(19) United States
(12) Patent Application Publication
(10) Pub. No.: US 2005/0213208 A1
(43) Pub. Date: Sep. 29, 2005

(54) Light transmissive screen, rear type projector, and method of designing light transmissive screen

(75) Inventor: Masafumi Sakaguchi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/085,199

(22) Filed: Mar. 22, 2005

(30) Foreign Application Priority Data
Mar. 24, 2004 (JP) 2004-087605

(51) Int. Cl. G03B 21/14

(52) U.S. Cl. 359/457

(57) ABSTRACT

To provide a light transmissive screen that can suppress a blur of the screen, a ghost image and dazzling feeling from occurring and thereby can obtain a high quality projection image, a light transmissive screen includes a Fresnel lens sheet; a lenticular lens sheet; and an optical bead sheet. The optical bead sheet and the Fresnel lens sheet are designed based on values of Gs, Hz and T, that are determined under the conditions that when the glossiness of the optical bead sheet, the haze value of the Fresnel lens sheet, a thickness of the Fresnel lens sheet and a scintillation value of the light transmissive screen, respectively, are denoted by Gs(60°), Hz, T and SI (=Gs/(T·Hz)), the SI comes into a predetermined range.

### BACKGROUND

Exemplary aspects of the present invention relate to a light transmissive screen, a rear type projector and a method of designing a light transmissive screen.

FIGS. 7(a) and 7(b) are schematics to explain a related art rear type projector. FIG. 7(a) is an external view and FIG. 7(b) is a sectional view. FIGS. 8(a) and 8(b) are schematics to explain problems of the related art rear type projector. FIG. 8(a) is a schematic showing an essential part of the related art rear type projector and FIG. 8(b) is a schematic in which light rays are added to FIG. 8(a).

A related art rear type projector 900, as shown in FIGS. 7(a) and 7(b), includes a projection optical unit 910 and a light guide mirror 920 disposed inside of a housing 950; and a light transmissive screen 930 disposed in front of the housing 950. Projection light from the projection optical unit 910 is reflected by the light guide mirror 920 and projected on the light transmissive screen 930.

The light transmissive screen 930, as shown in FIG. 8(a), includes a Fresnel lens sheet 932 that deflects the projection light from the projection optical unit 910 (not shown in FIG. 8(a)) so as to be substantially vertical to a screen; and a lenticular lens sheet 934 that controls a diffusion direction of the projection light.

### SUMMARY

However, in this related art rear type projector 900, as the projector becomes thinner, the light guide mirror 920 and the light transmissive screen 930 come close each other. Accordingly, as shown in FIG. 8(b), owing to the retro-reflection between a light incidence surface 932i of the Fresnel lens sheet 932 and the light guide mirror 920, a ghost image is generated. In this case, projection light L from the projection optical unit 910 (not shown in FIG. 8(b)) is reflected by the light guide mirror 920 and enters the Fresnel lens sheet 932. Thereafter, normal projection light Lc, that becomes original image light, enters the lenticular lens sheet 934 and is projected toward a viewer. The projection light L that enters the Fresnel lens sheet 932 is partially reflected by the light incidence surface 932i of the Fresnel lens sheet 932. The reflected light Lr is once again reflected by the light guide mirror 920 to be retro-reflection light, enters the Fresnel lens sheet 932, followed by projecting through the lenticular lens sheet 934, and thereby ghost light Lg that generates the ghost image is generated.

Accordingly, a rear type projector that can inhibit such a ghost image from occurring is in demand. FIGS. 9(a) and 9(b) are schematics showing essential parts of another related art rear type projectors that can inhibit the ghost image from occurring. FIG. 9(a) is a schematic showing an essential part of another related art rear type projector (1) and FIG. 9(b) is a schematic showing an essential part of still another related art rear type projector (2).

Among these, related art rear type projector (1) 900a, as shown in FIG. 9(a), includes, as a Fresnel lens sheet, a Fresnel lens sheet 932a on a light incidence surface 932ai of which fine irregularities A are formed. Accordingly, projection light incident on the Fresnel lens sheet 932a is diffused and reflected by the fine irregularities A formed on the light incidence surface 932ai and thereby the retro-reflection light can be effectively suppressed. As a result the ghost image Lg can be effectively inhibited from occurring JP-A No. 2004-4668 (FIGS. 1, 5 and 9).

Furthermore, related art rear type projector (2) 900b, as shown in FIG. 9(b), includes, on a light incidence surface side of the Fresnel lens sheet 932, a light transmissive sheet 936 on a light incidence surface 936i and a light exit surface 936o of which fine irregularities A are formed. Accordingly, projection light incident on the light transmissive sheet 936 is diffused and reflected by the fine irregularities A formed on the light incidence surface 936i and the light exit surface 936o. Thereby the retro-reflection light can be effectively suppressed, as a result, the ghost image can be effectively suppressed from occurring. See JP-A No. 2004-4668 (FIGS. 1, 5 and 9).

In related art rear type projector (1) 900a and related art rear type projector (2) 900b, in order to suppress the retro-reflection light, while suppressing a blur of a screen to an allowable value, the glossiness (Gs) of the light incidence surface 932ai of the Fresnel lens sheet 932a or the light transmissive sheet 936 is set at 35% or less and the haze values of the Fresnel lens sheets 932a and 932 are set at 33% or less.

However, in related art rear type projectors 900a and 900b, depending on selection of the glossiness (Gs) of the light incidence surface 932i of the Fresnel lens sheet or the light transmissive sheet and the haze value (Hz) of the Fresnel lens sheet, the dazzling feeling may be caused.

Exemplary aspects of the present invention provide: a light transmissive screen that can inhibit a blur, a ghost image and the dazzling feeling of an image plane from occurring, and thereby can obtain a high quality projection image; a rear type projector; and a method of designing a light transmissive screen that has such a light transmissive screen.

The inventors of the present invention found that when a light diffuser is disposed on a light incidence surface side of a Fresnel lens sheet, the glossiness (Gs(60°)) of the light diffuser, the haze value (Hz) of the Fresnel lens sheet and a thickness (T) of the Fresnel lens sheet are determined under the condition that a scintillation value (SI) of a light transmissive screen comes into a predetermined range. A rear type projector is constituted by use of the light transmissive screen that is designed based on these Gs, Hz and T as a light transmissive screen. Thus, the dazzling feeling in the light transmissive screen can be effectively reduced or suppressed.

A light transmissive screen according to an exemplary aspect of the invention includes a Fresnel lens sheet on a light exit surface of which a Fresnel lens is formed; a lenticular lens sheet that is disposed toward a light exit surface of the Fresnel lens sheet and on a light incidence surface of which a lenticular lens is formed; and light diffuser disposed toward a light incidence surface of the Fresnel lens sheet. The light diffuser and the Fresnel lens sheet are designed, when the glossiness of the light diffuser, the haze value of the Fresnel lens sheet, a thickness of the Fresnel lens sheet and a scintillation value of the light transmissive screen, respectively, are denoted by Gs, Hz, T and SI (=Gs/(T·Hz)) and the SI is determined so as to come in a predetermined range, based on values of Gs, Hz and T determined thus.

Accordingly, according to the light transmissive screen of an exemplary aspect of the invention, since the light diffuser is disposed toward the light incidence surface of the Fresnel lens sheet, a blur of the image plane and the ghost image can be sufficiently inhibited from occurring.

According to the light transmissive screen of an exemplary aspect of the invention, the glossiness (Gs) of the light diffuser, the haze value (Hz) of the Fresnel lens sheet and the thickness T of the Fresnel lens sheet are determined under the conditions where the scintillation value (SI) of the light transmissive screen may come in a predetermined range that can sufficiently suppress the dazzling feeling of the light transmissive screen from occurring. Accordingly, the dazzling feeling in the light transmissive screen can be inhibited from occurring.

As a result, according to the light transmissive screen according to an exemplary aspect of the invention, the blur of the image plane and the ghost image can be inhibited from occurring and the dazzling feeling also can be suppressed from occurring. Accordingly, a projection image with high image quality can be obtained.

In the light transmissive screen according to an exemplary aspect of the invention, the light diffuser may be an optical bead sheet on a light incidence surface of which many optical beads are disposed.

When the light transmissive screen is thus configured and a diameter of the optical bead, the refractive index thereof and a disposition density thereof are controlled, the glossiness (Gs) of the light diffuser can be arbitrarily controlled. Accordingly, the degree of freedom when the haze value (Hz) of the Fresnel lens sheet and the thickness thereof (T) are selected becomes higher. As a result, the blur of the image plane and the ghost image can be further easily inhibited from occurring and the dazzling feeling also can be suppressed from occurring. Thereby a projection image with high image quality can be obtained.

In the light transmissive screen according to an exemplary aspect of the invention, a diameter of the optical bead may be in the range of 10 to 15 μm.

When the light transmissive screen is thus configured, the dazzling feeling can be effectively suppressed from occurring.

In the light transmissive screen according to an exemplary aspect of the invention, the light diffuser may be provided with many projections on a light exit surface thereof and in contact with the Fresnel lens sheet with the light exit surface directed toward the Fresnel lens sheet.

In order to suppress the blur of the image plane from occurring, a distance between the light diffuser and the Fresnel lens sheet may be made shorter. The light diffuser and the Fresnel lens sheet may be brought into close contact with each other. However, when the light diffuser is brought into close contact with the Fresnel lens sheet, there is a problem in that moiré tends to occur. However, when the light transmissive screen is configured as mentioned above, even when a distance between the light diffuser and the Fresnel lens sheet is made shorter, the light diffuser and the Fresnel lens sheet do not come into close contact with each other. As a result, the moiré can be effectively suppressed from occurring.

In the light transmissive screen according to an exemplary aspect of the invention, the light diffuser may be formed into a matte state at a light exit surface thereof and in contact with the Fresnel lens sheet with the light exit surface thereof directed toward the Fresnel lens sheet.

When the light transmissive screen is thus configured as well, even when the light diffuser and the Fresnel lens sheet are made shorter in the distance therebetween, the light diffuser and the Fresnel lens sheet do not come into close contact with each other. As a result, the moiré can be effectively reduced or suppressed from occurring.

In the light transmissive screen according to an exemplary aspect of the invention, the light diffuser may be provided with an adhesive on a light exit surface thereof and solidly fixed to the Fresnel lens sheet with the light exit surface thereof directed toward the Fresnel lens sheet.

When the light transmissive screen is thus configured as well, since an adhesive layer is interposed between the light diffuser and the Fresnel lens sheet, even when the light diffuser and the Fresnel lens sheet are made shorter in the distance therebetween, the moiré can be effectively suppressed from occurring.

In the light transmissive screen according to an exemplary aspect of the invention, the light diffuser and the Fresnel lens sheet may be integrated.

When the light transmissive screen is thus configured as well, the interference between a light exit surface of the light diffuser and a light incidence surface of the Fresnel lens sheet does not occur. As a result, the blur of the image plane and the moiré can be effectively reduced or suppressed from occurring.

A rear type projector according to an exemplary aspect of the invention includes a projection optical unit, a light guide mirror and the abovementioned transmissive screen according to an exemplary aspect of the invention.

Accordingly, according to the rear type projector of an exemplary aspect of the invention, owing to the possession of such light transmissive screen, a high image quality rear type projector in which the blur of the image plane, the ghost image and the dazzling feeling are suppressed from occurring can be obtained.

A method of designing a light transmissive screen according to an exemplary aspect of the invention is a method of designing a light transmissive screen that includes: a Fresnel lens sheet on a light exit surface of which a Fresnel lens is formed; a lenticular lens sheet that is disposed toward the light exit surface of the Fresnel lens sheet and on a light incidence surface of which a lenticular lens is formed; and a light-diffuser disposed toward a light incidence surface of the Fresnel lens. When the glossiness of the light-diffuser, the haze value of the Fresnel lens sheet, a thickness of the Fresnel lens sheet and a scintillation value of the light transmissive screen, respectively, are denoted by Gs, Hz, T and SI (=Gs/(T·Hz)), under the condition that the SI comes in a predetermined range, values of Gs, Hz and T are determined.

Accordingly, according to the method of designing a light transmissive screen of an exemplary aspect of the invention, under the conditions where the scintillation value (SI) of the light transmissive screen may come in a predetermined range that can sufficiently suppress the dazzling feeling in the light transmissive screen, the glossiness (Gs) of the light diffuser, the haze value (Hz) of the Fresnel lens sheet and the thickness T of the Fresnel lens sheet can be determined. Accordingly, a light transmissive screen that can obtain a high image quality projection image by suppressing the blur of the screen, the ghost image and the dazzling feeling from occurring can be designed.

### BRIEF DESCRIPTION OF THE DRAWINGS

FIG. 1 is a schematic showing a sectional structure of a light transmissive screen of exemplary embodiment 1 according to an exemplary aspect of the present invention;

FIG. 2 is a schematic showing a sectional structure of a light transmissive screen of a modification example according to exemplary embodiment 1;

FIG. 3 is a schematic showing a sectional structure of a light transmissive screen of exemplary embodiment 2 according to an exemplary aspect of the invention;

FIG. 4 is a schematic showing a sectional structure of a light transmissive screen of exemplary embodiment 3 according to an exemplary aspect of the invention;

FIG. 5 is a schematic showing a sectional structure of a light transmissive screen of exemplary embodiment 4 according to an exemplary aspect of the invention;

FIG. 6 is a schematic showing a sectional structure of a light transmissive screen of exemplary embodiment 5 according to an exemplary aspect of the invention;

FIGS. 7(a) and 7(b) are schematics to explain a related art rear type projector;

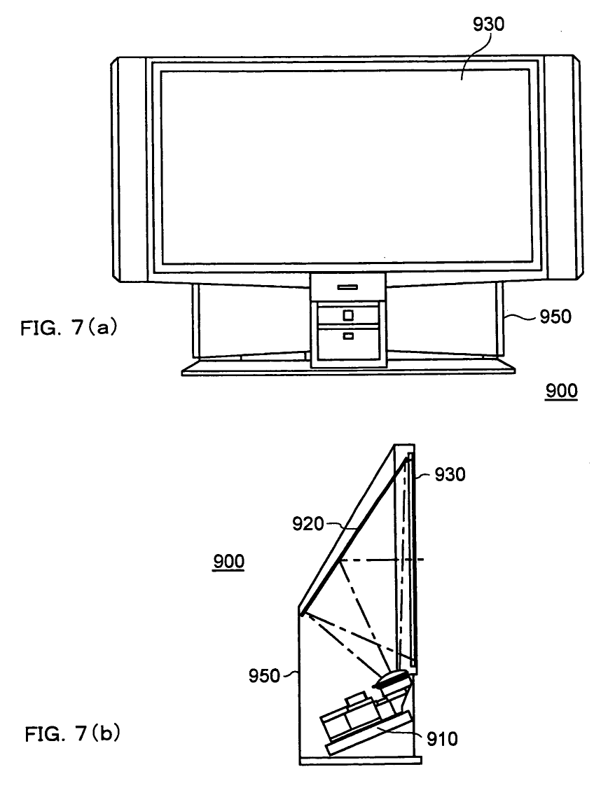

FIGS. 8(a) and 8(b) are schematics to explain problems of a related art rear type projector; and

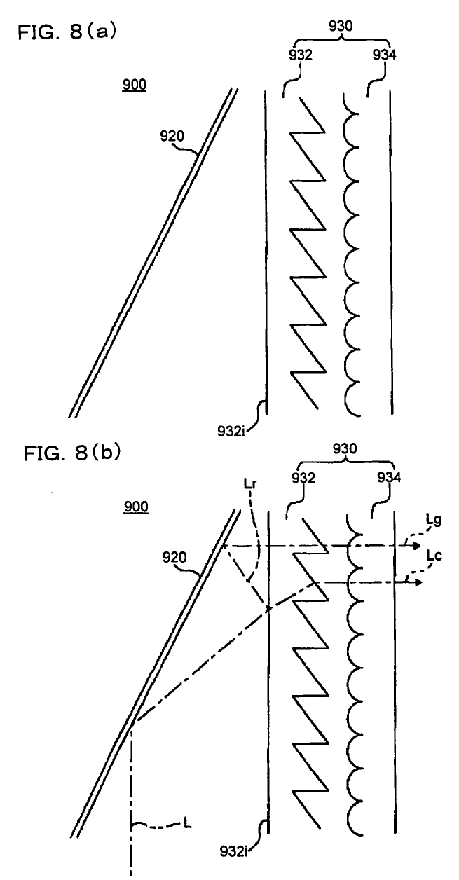

FIGS. 9(a) and 9(b) are schematics showing essential parts of a related art rear type projector.

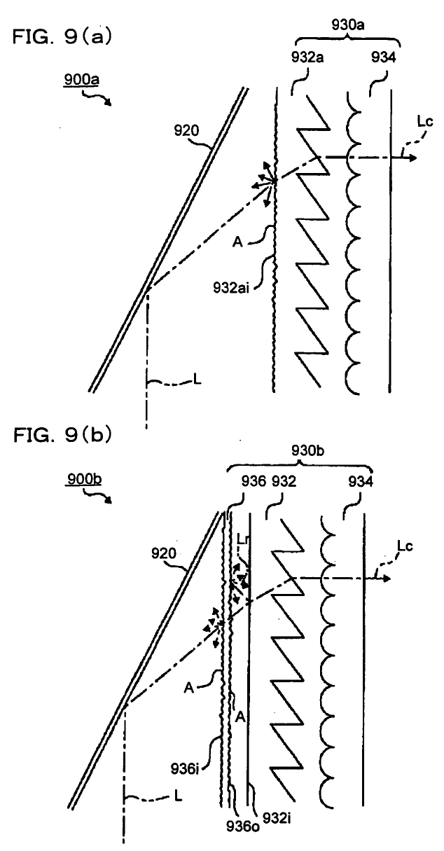

### DETAILED DESCRIPTION OF EXEMPLARY EMBODIMENTS

A light transmissive screen, a rear type projector and a method of designing a light transmissive screen will be described based on exemplary embodiments.

### Exemplary Embodiment 1

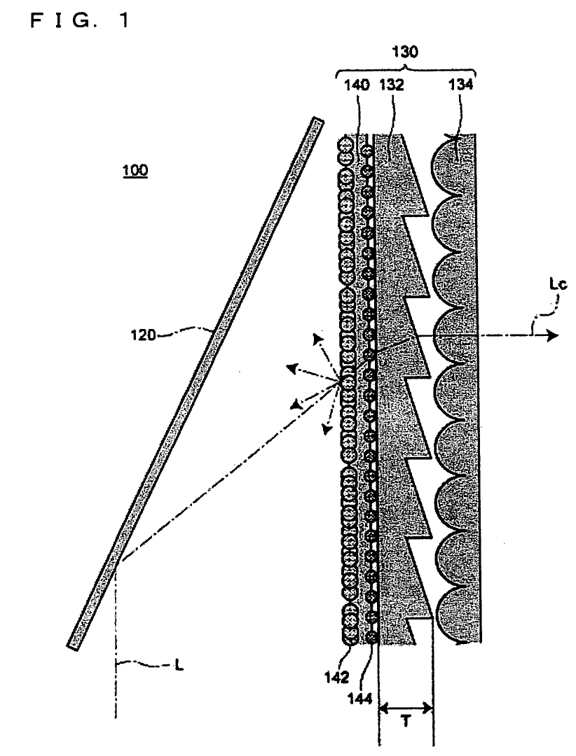

FIG. 1 is a schematic showing a sectional structure of a light transmissive screen of exemplary embodiment 1 of the invention.

A light transmissive screen 130 in a rear type projector 100 of exemplary embodiment 1 includes: a Fresnel lens sheet 132 on a light exit surface of which a Fresnel lens is formed; and a lenticular lens sheet 134 that is disposed toward the light exit surface of the Fresnel lens sheet 132 and on a light incidence surface of which a lenticular lens is formed. Toward the light incidence surface of the Fresnel lens sheet 132, as a light diffuser to suppress the retroreflection light, an optical bead sheet 140 on a light incidence surface of which many optical beads 142 are disposed is further disposed.

In the light transmissive screen 130 of the exemplary embodiment 1, under the conditions that when the glossiness of the optical bead sheet 140, the haze value of the Fresnel lens sheet 132, a thickness of the Fresnel lens sheet 132 and a scintillation value of the light transmissive screen 130, respectively, are denoted by Gs (60°), Hz, T and SI (=Gs/(T·Hz)), the SI may come into a predetermined range, values of the Gs, Hz and T are determined, and based on the values of Gs, Hz and T the optical bead sheet 140 and the Fresnel lens sheet 132 are designed.

In the light transmissive screen 130 of the exemplary embodiment 1, the glossiness (Gs) of the optical bead sheet 140 is 30%, the haze value (Hz) of the Fresnel lens sheet 132 is 90%, and the thickness (T) of the Fresnel lens sheet 132 is 1 mm. The optical bead sheet 140 and the Fresnel lens sheet 132 are fixed at top and bottom ends with a double-sided adhesive tape.

Accordingly, according to the light transmissive screen 130 of the exemplary embodiment 1, since the optical bead sheet 140 is disposed toward a light incidence surface of the Fresnel lens sheet 132, the blur of the screen and the ghost image can be sufficiently suppressed from occurring.

According to the light transmissive screen 130 of the exemplary embodiment 1, the glossiness (Gs) of the optical bead sheet 140, the haze value (Hz) of the Fresnel lens sheet 132 and the thickness T of the Fresnel lens sheet 132 are determined under the conditions where the scintillation value (SI) of the light transmissive screen 130 may come into a predetermined range that can sufficiently suppress the dazzling feeling of the light transmissive screen 130 from occurring. Accordingly, the dazzling feeling in the light transmissive screen 130 can be sufficiently inhibited from occurring.

As a result, according to the light transmissive screen 130 of the exemplary embodiment 1, the blur of the screen and the ghost image can be inhibited from occurring and the dazzling feeling also can be suppressed from occurring, and thereby a projection image with high image quality can be obtained.

In the light transmissive screen 130 of the exemplary embodiment 1, as a light diffuser to suppress the retroreflection light, the optical bead sheet 140 on a light incidence surface of which many optical beads are disposed is used. Accordingly, when a diameter of the optical bead, the refractive index of the optical bead and disposition density of the optical beads are controlled, the glossiness (Gs) of the optical bead sheet can be arbitrarily controlled. Accordingly, the degree of freedom when the haze value (Hz) of the Fresnel lens sheet and the thickness thereof (T) are selected becomes higher. As a result, the blur of the screen, the generation of the ghost image and the dazzling feeling as well, can be further easily inhibited from occurring, and thereby a projection image with high image quality can be obtained.

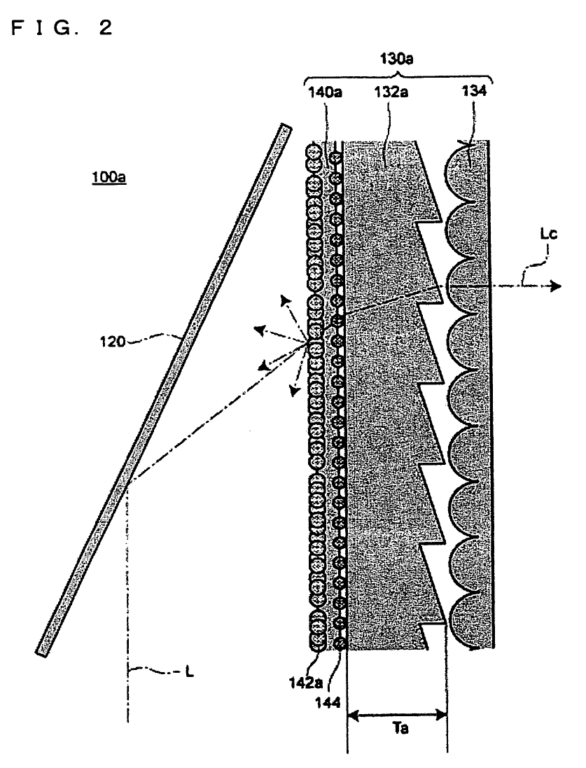

FIG. 2 is a schematic showing a schematic of a light transmissive screen of a modification example of exemplary embodiment 1.

In a light transmissive screen 130a in a rear type projector 100a, a thickness of the Fresnel lens sheet 132 in the light transmissive screen 130 of exemplary embodiment 1 is made twice. However, when the light transmissive screen 130a is designed, under the conditions that when the glossiness of the optical bead sheet 140a, the haze value of the Fresnel lens sheet 132a, a thickness of the Fresnel lens sheet 132a and a scintillation value of the light transmissive screen 130a, respectively, are denoted by Gs, Hz, T and SI (=Gs/(T·Hz)), the SI may come into a predetermined range, values of Gs, Hz and T are determined, and, based on the values of Gs, Hz and T, the optical bead sheet 140a and the Fresnel lens sheet 132a are designed.

In the light transmissive screen 130a involving a modification of exemplary embodiment 1, the glossiness (Gs) of the optical bead sheet 140a is 30%, the haze value (Hz) of the Fresnel lens sheet 132a is 70%, and the thickness (T) of the Fresnel lens sheet 132a is 2 mm. The optical bead sheet 140a and the Fresnel lens sheet 132a are fixed at top and bottom ends with a double-sided adhesive tape.

Accordingly, according to the light transmissive screen 130a involving a modification example of exemplary embodiment 1, since the optical bead sheet 140a is disposed toward a light incidence surface of the Fresnel lens sheet 132a, similarly to the case of the light transmissive screen 130 involving exemplary embodiment 1, the blur of the screen and the ghost image can be sufficiently suppressed from occurring.

Furthermore, according to the light transmissive screen 130a involving a modification example of exemplary embodiment 1, the glossiness (Gs) of the optical bead sheet 140a, the haze value (Hz) of the Fresnel lens sheet 132a and the thickness (T) of the Fresnel lens sheet 132a are determined under the conditions where the scintillation value (SI) of the light transmissive screen 130a may come into a predetermined range that can sufficiently suppress the dazzling feeling of the light transmissive screen 130a from occurring. Accordingly, similarly to the light transmissive screen 130 of exemplary embodiment 1, the dazzling feeling in the light transmissive screen 130a can be sufficiently inhibited from occurring.

As a result, according to the light transmissive screen 130a of a modification of exemplary embodiment 1 as well, the blur of the screen and the ghost image can be inhibited from occurring and the dazzling feeling also can be reduced or suppressed from occurring, and thereby a projection image with high image quality can be obtained.

Referring again to FIG. 1, in the light transmissive screen 130 involving exemplary embodiment 1, a diameter of the optical bead 142 can be adequately selected from a value in the range of 10 to 150 μm. When the diameter is in the range, by combining the haze value (Hz) and the thickness (T) of the Fresnel lens sheet 132, the blur of the screen, the ghost image and the dazzling feeling can be suppressed from occurring, and thereby a projection image with sufficiently high image quality can be obtained.

In the light transmissive screen 130 of exemplary embodiment 1, on a light exit surface of the optical bead sheet 140, projections 144 are formed by embossing. The optical bead sheet 140 is in contact with the Fresnel lens sheet 132 with the light exit surface directed toward the Fresnel lens sheet 132.

In order to suppress the blur of the screen from occurring, a distance between the optical bead sheet 140 and the Fresnel lens sheet 132 may be made shorter. Specifically, the optical bead sheet 140 may be brought into close contact with the Fresnel lens sheet 132. However, when the optical bead sheet 140 is brought into close contact with the Fresnel lens sheet 132, there is a problem in that the moire tends to occur. However, when the light transmissive screen is configured as mentioned above, even when a distance between the optical bead sheet 140 and the Fresnel lens sheet 132 is made shorter, the optical bead sheet 140 and the Fresnel lens sheet 132 do not come into close contact with each other. As a result, the moiré can be effectively suppressed from occurring.

As mentioned above, since the rear type projector 100 of exemplary embodiment 1 includes a projection optical unit 110, a light guide mirror 120 and a light transmissive screen 130, the blur of the image plane, the image ghost and the dazzling feeling can be inhibited from occurring. Accordingly, a rear type projector with high image quality can be obtained.

In exemplary embodiment 1, as mentioned above, when the light transmissive screen 130, that includes: the Fresnel lens sheet 132 on a light exit surface of which a Fresnel lens is formed, the lenticular lens sheet 134 that is disposed toward the light exit surface of the Fresnel lens sheet 132 and on a light incidence surface of which a lenticular lens is formed, and the optical bead sheet 140 disposed toward a light incidence surface of the Fresnel lens sheet 132, is designed, when the glossiness of the optical bead sheet 140, the haze value of the Fresnel lens sheet 132, a thickness of the Fresnel lens sheet 132 and a scintillation value of the light transmissive screen 130, respectively, are denoted by Gs, Hz, T and SI (=Gs/(T·Hz)), under a condition that the SI comes into a predetermined range, values of Gs, Hz and T are determined. Thereby, the blur of the image plane, the ghost image and the dazzling feeling can be reduced or suppressed from occurring. Accordingly, the light transmissive screen 130 that can obtain a projection image with sufficiently high image quality can be designed.

However, the effect can be similarly obtained even when, as the light diffuser to suppress the retroreflection light, a light diffuser other than the optical bead sheet is used.

### Exemplary Embodiment 2

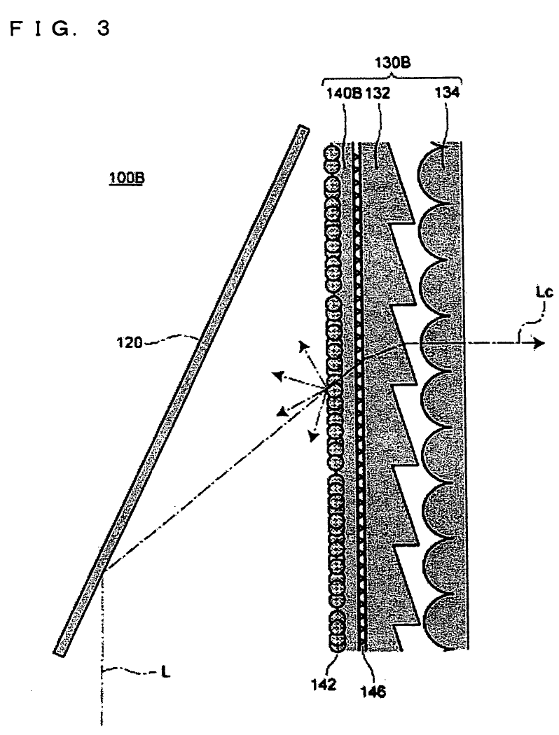

FIG. 3 is a schematic showing a sectional structure of a light transmissive screen of an exemplary embodiment 2 according to an exemplary aspect of the invention.

A light transmissive screen 130B involving an exemplary embodiment 2 is different in a constitution of an optical bead sheet from the light transmissive screen 130 of exemplary embodiment 1. Specifically, the light transmissive screen 130B of exemplary embodiment 2, as shown in FIG. 3, different from the light transmissive screen 130 of exemplary embodiment 1, includes an optical bead sheet 140B on a light exit surface of which many particles 146 are disposed into a matte state. The optical bead sheet 140B, with a light exit surface directed toward the Fresnel lens sheet 132, is in contact with the Fresnel lens sheet 132.

Thus, the light transmissive screen 130B of exemplary embodiment 2 includes the optical bead sheet 140B on a light exit surface of which many particles 146 are disposed and comes into contact with the Fresnel lens sheet 132 with the light exit surface thereof directed toward the Fresnel lens sheet 132. Accordingly, even when a distance between the optical bead sheet 140B and the Fresnel lens sheet 132 is made shorter, the optical bead sheet 140B and the Fresnel lens sheet 132 are not brought into close contact with each other. As a result, similarly to the case of the light transmissive screen 130 of exemplary embodiment 1, the moiré can be effectively reduced or suppressed from occurring.

The light transmissive screen 130B of exemplary embodiment 2 has, other than the above points, a similar configuration as the light transmissive screen 130 of exemplary embodiment 1. Accordingly, similarly, it has the effects of the light transmissive screen 130 of exemplary embodiment 1.

### Exemplary Embodiment 3

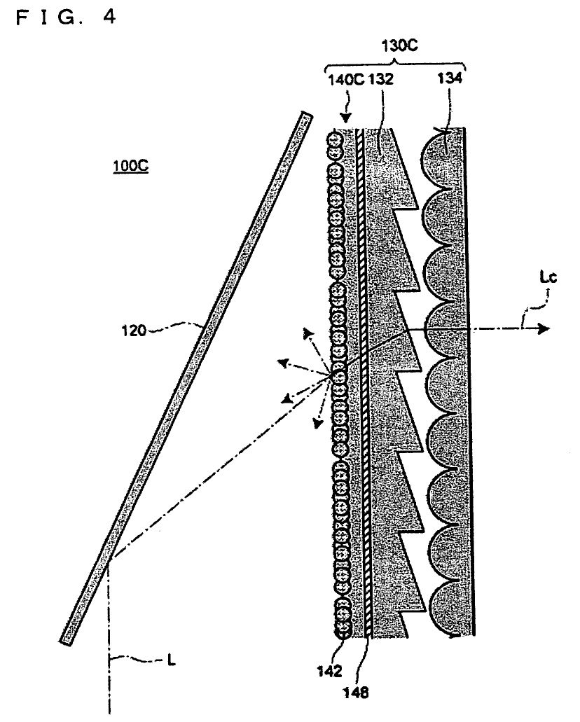

FIG. 4 is a schematic showing a sectional structure of a transmissive screen of exemplary embodiment 3 according to an exemplary aspect of the invention.

A light transmissive screen 130C of exemplary embodiment 3 is different, in a configuration of an optical bead sheet, from the light transmissive screens 130 and 130B of exemplary embodiments 1 and 2. Specifically, the light transmissive screen 130C of exemplary embodiment 3, as shown in FIG. 4, different from the light transmissive screens 130 and 130B of exemplary embodiments 1 and 2, is provided with an optical bead sheet 140C on a light exit surface of which an adhesive is coated. The optical bead sheet 140C is fixed (adhered) to a Fresnel lens sheet 132 with the light exit surface directed toward the Fresnel lens sheet 132.

Thus, the light transmissive screen 130C of exemplary embodiment 3 is provided with the optical bead sheet 140C on a light exit surface of which an adhesive is coated and fixed to a Fresnel lens sheet 132 with the light exit surface thereof directed toward the Fresnel lens sheet 132. Thereby, between the optical bead sheet 140C and the Fresnel lens sheet 132 an adhesive layer 148 is interposed. Accordingly, even when a distance between the optical bead sheet 140C and the Fresnel lens sheet 132 is made shorter, similarly to the light transmissive screens 130 and 130B of exemplary embodiments 1 and 2, the moiré can be effectively inhibited from occurring.

The light transmissive screen 130C of exemplary embodiment 3, having a configuration identical to that of the light transmissive screen 130 of exemplary embodiment 1 except for the above points, similarly has the effects of the light transmissive screen 130 of exemplary embodiment 1.

### Exemplary Embodiment 4

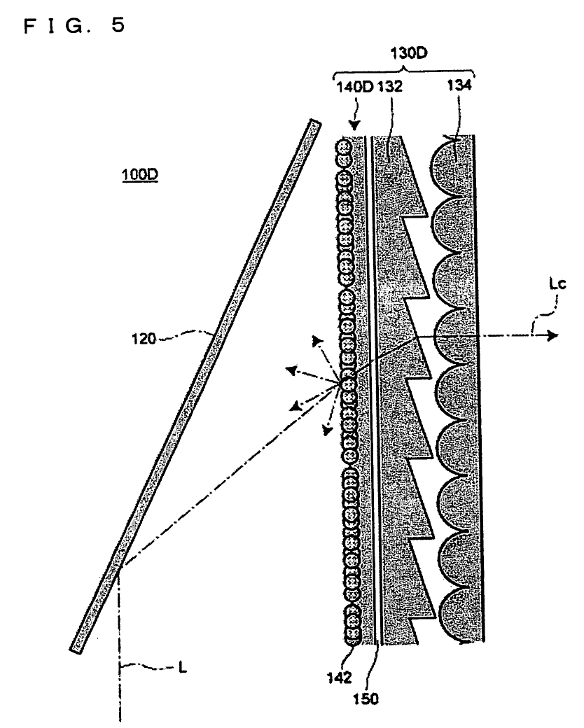

FIG. 5 is a schematic showing a sectional structure of a transmissive screen involving exemplary embodiment 4 according to an exemplary aspect of the invention.

A light transmissive screen 130D of exemplary embodiment 4 is different in a point that an optical bead sheet and a Fresnel lens sheet are not in contact with each other from the light transmissive screen 130C involving exemplary embodiment 3.

Thus, in the light transmissive screen 130D of exemplary embodiment 4, since the optical bead sheet 140D and the Fresnel lens sheet 132 are not in contact with each other. Specifically, since the optical bead sheet 140D and the Fresnel lens sheet 132 are disposed through an air layer 150, similarly to the light transmissive screen 130C of exemplary embodiment 3, the moiré can be effectively inhibited from occurring.

The light transmissive screen 130D of exemplary embodiment 4, having a configuration identical to that of the light transmissive screen 130C of exemplary embodiment 3 except for the above points, similarly has the effects that the light transmissive screen 130C of exemplary embodiment 3.

### Exemplary Embodiment 5

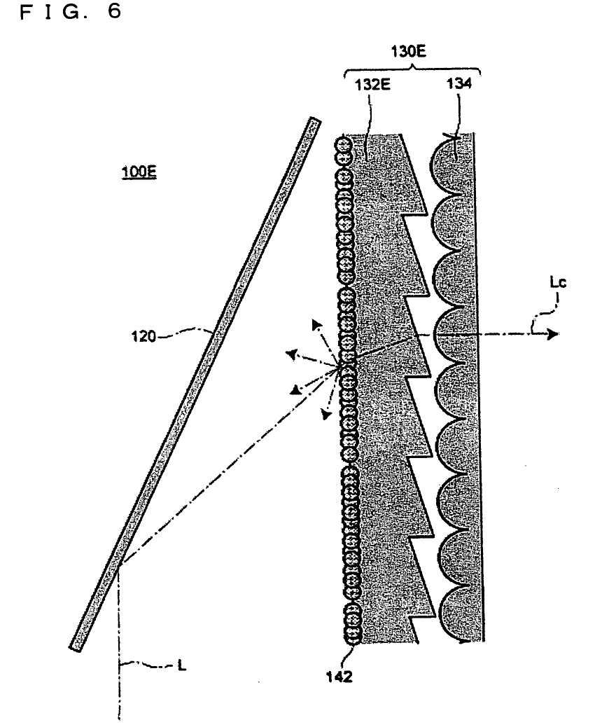

FIG. 6 is a schematic showing a sectional structure of a transmissive screen of exemplary embodiment 5 according to an exemplary aspect of the invention.

A light transmissive screen 130E of exemplary embodiment 5 is different, in configurations of an optical bead sheet and a Fresnel lens sheet, from the light transmissive screens 130, 130B, 130C and 130D of exemplary embodiments 1 through 4. Specifically, in the light transmissive screen 130E of exemplary embodiment 5, as shown in FIG. 6, different from the light transmissive screens 130, 130B, 130C and 130D of exemplary embodiments 1 through 4, the optical bead sheet and the Fresnel lens sheet are integrated. Specifically, on a light incidence surface of the Fresnel lens sheet 132E, many optical beads 142 are disposed.

Thus, the light transmissive screen 130E of exemplary embodiment 5 is provided with the Fresnel lens sheet 132E in which the optical bead sheet and the Fresnel lens sheet are integrated. Accordingly, the interference between a light exit surface of the optical bead sheet and a light incidence surface of the Fresnel lens sheet is not caused. Accordingly, similarly to the light transmissive screens 130, 130B, 130C and 130D of exemplary embodiments 1 through 4, the moiré can be effectively inhibited from occurring. Furthermore, owing to the presence of such a Fresnel lens sheet 132E, even when a distance between the light diffusing surface and the Fresnel lens sheet is made shorter, the moiré can be effectively inhibited from occurring.

The light transmissive screen 130E of exemplary embodiment 5, having a configuration identical to that of the light transmissive screens 130, 130B, 130C and 130D of exemplary embodiments 1 through 4 except for the above points, similarly has the effects that the light transmissive screens 130, 130B, 130C and 130D of exemplary embodiments 1 through 4.

In the above, the light transmissive screens, rear type projectors and methods of designing the light transmissive screens according to exemplary aspects of the invention are explained based on the respective exemplary embodiments; however, the present invention is not restricted to the above exemplary embodiments. Specifically, within a range that does not deviate from the gist, it can be carried out in various modes, and modifications such as shown below can be applied as well.

(1) A light transmissive screen may further have, on a light exit surface side of the lenticular lens sheet 134, other optical elements, such as black stripes and a light diffusing plate.

(2) A light transmissive screen may have, instead of the lenticular lens 134, a micro-lens sheet.

1. A light transmissive screen, comprising:
a light exit surface of which a Fresnel lens is formed;
a Fresnel lens sheet on the light exit surface;
a lenticular lens sheet that is disposed toward the light exit surface of the Fresnel lens sheet and provided with a lenticular lens formed on a light incidence surface; and
a light diffuser disposed toward a light incidence surface of the Fresnel lens sheet,
when the glossiness of the light diffuser, the haze value of the Fresnel lens sheet, a thickness of the Fresnel lens sheet and a scintillation value of the light transmissive screen, respectively, are denoted by Gs(60°), Hz, T and SI (=Gs(60°)/(T·Hz)), and the values of Gs(60°), Hz and T are determined so that the SI comes into a predetermined range, the light diffuser and the Fresnel lens sheet are designed based on the values of Gs(60°), Hz and T.

2. The light transmissive screen according to claim 1, the light diffuser being an optical bead sheet on a light incidence surface thereof a lot of optical beads are disposed.

3. The light transmissive screen according to claim 2, a diameter of the optical bead being in the range of 10 to 150 μm.

4. The light transmissive screen according to claim 1, the light diffuser, having many projections formed on a light exit surface and the light exit surface directed toward the Fresnel lens sheet, and being in contact with the Fresnel lens sheet.

5. The light transmissive screen according to claim 1, the light diffuser, having a light exit surface rendered matte and the light exit surface directed toward the Fresnel lens sheet, being in contact with the Fresnel lens sheet.

6. The light transmissive screen according to claim 1, the light diffuser, having a light exit surface coated with an adhesive and the light exit surface directed toward the Fresnel lens sheet, being in contact with the Fresnel lens sheet.

7. The light transmissive screen according to claim 1, the light diffuser and the Fresnel lens being integrated.

8. A rear type projector comprising:
a projection optical unit;
a light-guide mirror; and
the light transmissive screen according to claim 1.

9. A method of designing a light transmissive screen, comprising:
designing a light transmissive screen that includes a Fresnel lens sheet on a light exit surface of which a Fresnel lens is formed;
a lenticular lens sheet that is disposed toward the light exit surface of the Fresnel lens sheet and provided with a lenticular lens formed on a light incidence surface; and
a light diffuser disposed toward a light incidence surface of the Fresnel lens sheet,
when the glossiness of the light-diffuser, the haze value of the Fresnel lens sheet, a thickness of the Fresnel lens sheet and a scintillation value of the light transmissive screen, respectively, are denoted by Gs(60°), Hz, T and SI (=Gs(60°)/(T·Hz)), under a condition that the SI comes into a predetermined range, values of Gs(60°), Hz and T are determined.
